(19) United States
(12) Patent Application Publication
(10) Pub. No.: US 2024/0045923 A1
(43) Pub. Date: Feb. 8, 2024

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Daiki KIRIBUCHI, Ota (JP); Hiro GANGI, Ota (JP)

(73) Assignee: KABUSHIKI KAISHA TOSHIBA, Tokyo (JP)

(21) Appl. No.: 18/172,413

(22) Filed: Feb. 22, 2023

(30) Foreign Application Priority Data
Aug. 3, 2022 (JP) 2022-123773

(51) Int. Cl. G06F 17/18

(52) U.S. Cl. CPC G06F 17/18

(57) ABSTRACT

According to an embodiment, an information processing device includes one or more hardware processors configured to: based on a constraint function value that is an output of a constraint function when one or more first set values are input for one or more parameters, estimate a first estimation value and a first estimation error of the constraint function value; and based on the first estimation value and the first estimation error, calculate a robust satisfaction probability representing a probability that one or more second set values for the one or more parameters satisfy a robust constraint that the constraint function value when inputting a plurality of third set values should satisfy, the plurality of third set values being obtained by changing the one or more second set values in a neighborhood range determined in advance based on the one or more second set values.

### CROSS-REFERENCE TO RELATED APPLICATIONS

This application is based upon and claims the benefit of priority from Japanese Patent Application No. 2022-123773, filed on Aug. 3, 2022; the entire contents of which are incorporated herein by reference.

### FIELD

Embodiments described herein relate generally to an information processing device, an information processing method, and a computer program product.

### BACKGROUND

Optimization based on simulations has been practically used for examining improvement guidelines in various fields. For example, in a manufacturing system for manufacturing a product, set values of design parameters are obtained through optimization so that an objective function value (output of an objective function), which corresponds to an evaluation value of the product, satisfies a condition.

In optimization, a constraint function value (output of a constraint function) is required to always satisfy a condition, in some cases, in addition to the objective function value satisfying the condition. An example of an implementation means may include a function of determining whether a set value satisfies a constraint for one parameter by executing a plurality of times of simulations.

### BRIEF DESCRIPTION OF THE DRAWINGS

FIG. 1 is a block diagram of an information processing system according to an embodiment;

FIG. 2 is a diagram illustrating an example of data related to a setting range;

FIG. 3 is a diagram illustrating an example of data related to a neighborhood range;

FIG. 4 is a diagram illustrating an example of a data set;

FIG. 5 is a flowchart of determination processing according to the embodiment;

FIG. 6 is a diagram illustrating an example of a display screen displaying an estimated robust satisfaction probability;

FIG. 7 is a diagram illustrating an example of a display screen displaying an estimated optimum value and robust satisfaction probability; and

FIG. 8 is a hardware configuration diagram of an information processing device according to the embodiment.

### DETAILED DESCRIPTION

According to an embodiment, an information processing device includes one or more hardware processors configured to: based on a constraint function value that is an output of a constraint function when one or more first set values are input for one or more parameters, estimate a first estimation value and a first estimation error of the constraint function value; and based on the first estimation value and the first estimation error, calculate a robust satisfaction probability representing a probability that one or more second set values for the one or more parameters satisfy a robust constraint that the constraint function value when inputting a plurality of third set values should satisfy, the plurality of third set values being obtained by changing the one or more second set values in a neighborhood range determined in advance based on the one or more second set values.

Exemplary embodiments of an information processing device according to the present invention will be explained below in detail with reference to the accompanying drawings.

As a technique of obtaining a set value of a parameter with a small number of trials, for example, there is known Bayesian optimization for enabling a set value of a parameter to be efficiently adjusted. In the following embodiment, a set value of a parameter is estimated by using Bayesian optimization.

Optimization according to the present embodiment can be, for example, applied to a case of obtaining an optimum set value of a parameter (design parameter) used for manufacturing a product to improve productivity, a yield, and reliability of a manufacturing system for manufacturing a product such as a semiconductor.

In the manufacturing system, for example, a machining time, dimensions, resistance, a voltage, an electric charge, and the like are used as design parameters. An objective function is a function for obtaining an evaluation value (a quality characteristic, a fraction defective, and the like) of a product using such design parameters. A constraint function is a function indicating a constraint related to these design parameters.

A system to which the embodiment can be applied is not limited to such a manufacturing system, but may be any system. For example, the embodiment can be applied to processing of obtaining an optimum value of a parameter used in a power generation plant or an optimum value of a hyperparameter used in machine learning.

A set value estimated by optimization including the Bayesian optimization may be deviated from an optimum set value of a parameter used in an actual system due to various factors. Also in such a case, influence thereof is required to be minimized. For example, even if the estimated set value is slightly deviated from the optimum set value, it is desirable to minimize influence on an objective function value and minimize influence on a constraint function value. The slightly deviated set value is a set value included in a neighborhood range determined in advance around a set value as a standard.

In the following description, a robust constraint means a constraint indicating that a constraint function value always satisfies a condition even if a set value of a parameter is slightly deviated from an optimum set value. In the present embodiment, the set value is estimated so that, even if the estimated set value is slightly deviated from the optimum set value, influence on the objective function value is minimized and the robust constraint is satisfied.

In the present embodiment, it is possible to determine whether the robust constraint is satisfied without performing a plurality of times of simulations, for example. Accordingly, processing of obtaining the set value of the parameter can be performed more efficiently.

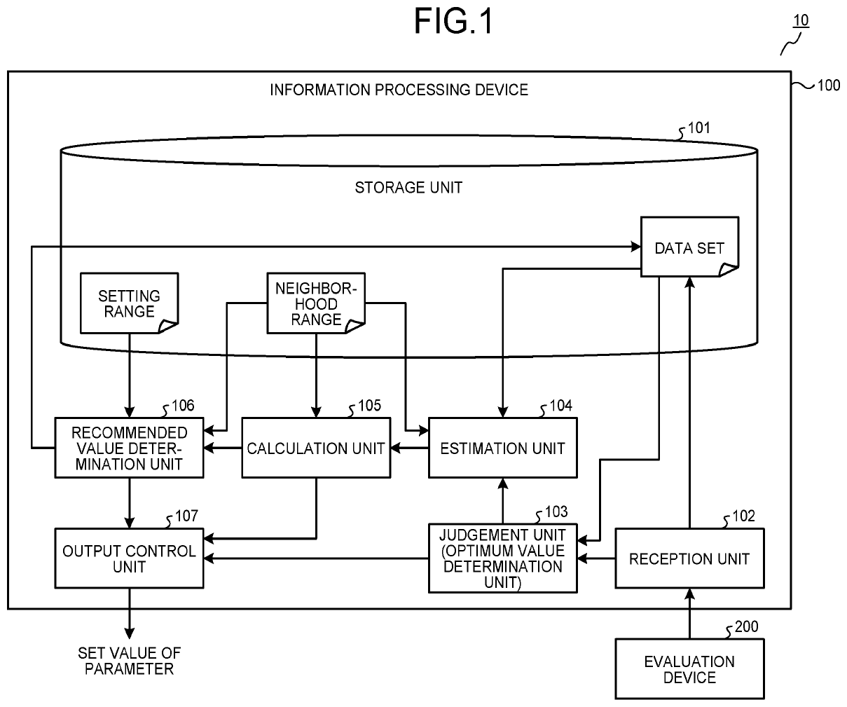

FIG. 1 is a block diagram illustrating an example of an information processing system 10 according to the present embodiment. The information processing system 10 includes an information processing device 100 and an evaluation device 200. The information processing device 100 includes a storage unit 101, a reception unit 102, a judgement unit (optimum value determination unit) 103, an estimation unit 104, a calculation unit 105, a recommended value determination unit 106, and an output control unit 107.

The information processing device 100 recommends a set value of a parameter used for a simulation or an experiment. For example, a simulation model having parameters is used in the simulation, and values set as the parameters of the simulation model, that is, set values are recommended. Alternatively, for example, assuming that an amount of samples used in the experiment is a parameter, a value of the amount may be recommended. Unless otherwise specifically noted in the following description, a term of “experiment” encompasses a simulation.

The evaluation device 200 evaluates a result of an experiment based on the recommended set value, and generates information about the evaluation. The information includes an objective function value (evaluation value), a constraint function value (constraint value), and the like. The evaluation device 200 may perform a simulation based on the recommended set value, and generate information about evaluation of the simulation. Alternatively, when a user performs an experiment based on the recommended set value and inputs an experiment result to the evaluation device 200, the evaluation device 200 may generate information about evaluation of the experiment.

The information processing device 100 acquires, from the evaluation device 200, information about evaluation of the result of the experiment based on the recommended set value, and recommends the set value again based on the information. In other words, the information processing device 100 recommends a set value to be used for the next experiment. In this way, an optimum set value is obtained by repeating recommendation of the set value. In other words, an optimum value of a parameter is estimated. Hereinafter, the optimum set value is referred to as an optimum value.

In the present embodiment, the optimum value is a value that is assumed to be optimum by the information processing device 100 regardless of whether the value is actually optimum. A plurality of values may be judged to be optimum values. That is, a plurality of values may be output as optimum values. The number of parameters for which optimum values are obtained (also referred to as the number of items of a model, or the number of dimensions) may be one or multiple.

In the example of FIG. 1, the information processing device 100 outputs the recommended set value to the outside, and acquires information about the result of the experiment from the outside. However, the information processing device 100 may include a simulator that executes the experiment in some cases. That is, the information processing device 100 may also serve as a simulator.

The following describes an optimization problem (a black box optimization problem with a robust constraint) treated in the present embodiment. In the present embodiment, considered are an objective function f(x) and a constraint function c(x) on a set X⊂R^{D}. D is the number of parameters (the number of items of a model, the number of dimensions). As a result of performing a simulation (or an experiment) with a set value x∈X of a certain parameter, f(x) is obtained as the objective function value and c(x) is obtained as the constraint function value.

A black box optimization problem with a normal constraint, which does not take into account a robust constraint, is a problem of obtaining a set value of a parameter the constraint function value of which satisfies a condition determined in advance (a condition for the constraint function value) and the objective function value of which satisfies a condition determined in advance (a condition for the objective function value).

The condition for the constraint function value indicates, for example, that the constraint function value is equal to or smaller than a threshold, equal to or larger than the threshold, or equal to or larger than a threshold 1 and equal to or smaller than a threshold 2.

In a case in which a smaller objective function value indicates better evaluation, the condition for the objective function value indicates that the objective function value is smaller than the other set values (for example, the objective function value is the smallest), for example. In a case in which a larger objective function value indicates better evaluation, the condition for the objective function value indicates that the objective function value is smaller than the other set values (for example, the objective function value is the largest), for example.

The following mainly exemplifies the case in which a smaller objective function value indicates better evaluation. Regarding the case in which a larger objective function value indicates better evaluation, for example, “the objective function value is smaller than the other set values (the objective function value is the smallest)” may be replaced with “the objective function value is larger than the other set values (the objective function value is the largest)”.

In a case in which the condition for the constraint function value indicates that the constraint function value is equal to or smaller than a threshold 0, and the condition for the objective function value indicates that the objective function value is the smallest, the black box optimization problem with a constraint is represented by the following expression (1).

min f(x) s.t.c(x)≤0 (1)

As described above, in a case of adjusting an operating system or manufacturing a product using a set value that is assumed to be optimum, a setting may be slightly deviated from the set value that is assumed to be optimum due to various factors. In such a case, the constraint function value is required to be equal to or smaller than the threshold.

In the present embodiment, considered is a robust constraint in which c(x+δ) always satisfies the condition for the constraint function value (equal to or smaller than the threshold, equal to or larger than the threshold, equal to or larger than the threshold 1 and equal to or smaller than the threshold 2, or the like) even if the set value of the parameter varies by δ. δ is a value satisfying δ∈Δ(x) (⊂R_{D}). Δ(x) corresponds to a neighborhood range.

A robust constraint value c*(x) is defined as a maximum value or a minimum value of c(x+δ) at the time when the set value of the parameter varies by δ∈Δ(x). In a case of the maximum value, the robust constraint value c*(x) is represented by the following expression (2), for example.

$${c}^{*} ( x ) = {max}_{δ ∈ Δ ( x )} c ( x + δ ) \qquad ( 2 )$$

The black box optimization problem with a robust constraint treated in the present embodiment is a problem of obtaining a set value of a parameter the robust constraint value c*(x) of which satisfies a condition determined in advance (the condition for the constraint function value) and the objective function value of which satisfies a condition determined in advance (the condition for the objective function value). The black box optimization problem with a robust constraint is represented by the following expression (3), for example.

$$min f ( x ) s . t . {c}^{*} ( x ) = {max}_{δ ∈ Δ ( x )} c ( x + δ ) \leq 0 \qquad ( 3 )$$

Next, the following describes an internal configuration of the information processing device 100. The constituent elements illustrated in FIG. 1 are elements for performing processing of determining a set value to be recommended next, and other constituent elements are not illustrated therein. The constituent elements may be subdivided or integrated with each other. For example, the storage unit 101 may be divided into a plurality of storage units (storage media) depending on a file and the like to be stored therein. The constituent elements other than the storage unit 101 may be assumed to be arithmetic units. A processing result of each of the constituent elements may be transmitted to the constituent element by which the next processing is performed, or may be stored in the storage unit 101. In the latter case, the constituent element by which the next processing is performed may access the storage unit 101 to acquire the processing result.

The storage unit 101 stores data used for processing performed by the information processing device 100. The data includes at least data indicating a setting range, data indicating a neighborhood range, and a data set. The storage unit 101 may also store data other than the above data. For example, the storage unit 101 may store a processing result and the like of each of the constituent elements of the information processing device 100.

The setting range means a range that may be taken by the set value. In other words, the setting range means a range of a value that can be set for the parameter, and is a search range for searching for a set value to be recommended. The setting range is input by the user and the like, for example, and stored in the storage unit 101 in advance.

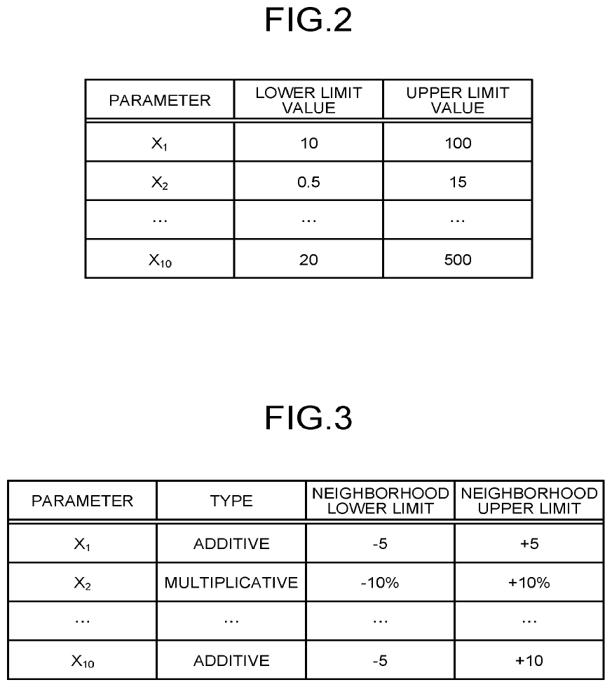

FIG. 2 is a diagram illustrating an example of data related to the setting range. As illustrated in FIG. 2, for example, there are 10 parameters from X₁ to X₁₀. A lower limit value and an upper limit value are determined for each of the parameters. The setting range is a range from the lower limit value to the upper limit value. For example, the setting range of the parameter Xi is a range from 10 to 100.

A method of representing the setting range is not particularly limited. For example, a matrix A and a vector B may be stored, and W satisfying AW+B<0 may be assumed to be the setting range. Alternatively, a vector A and a real number R may be stored, and W satisfying |W−A|<R may be assumed to be the setting range. Herein, |W−A| represents magnitude of a vector “W−A”. Additionally, parameters of various inequalities may be stored, and W satisfying the inequality may be assumed to be the setting range.

The neighborhood range is a range based on the set value to be applied to the recommended set value, and indicates a range of a value that is assumed to be close to the set value. Whether the set value is robust is judged by using the neighborhood range.

FIG. 3 is a diagram illustrating an example of data related to the neighborhood range. As illustrated in FIG. 3, the neighborhood range is obtained in accordance with the set value of the parameter for each of the parameters. A method of representing the neighborhood range may be the same as or different from that for the setting range.

“Additive” in an item of “type” means that, assuming that a neighborhood lower limit of a set value x of a certain parameter X is L and a neighborhood upper limit thereof is U, a range of x+L through x+U, both inclusive, is assumed to be the neighborhood range. For example, regarding the parameter X₁, illustrated is the fact that the neighborhood lower limit is −5 and the neighborhood upper limit is +5. Thus, when the set value of the parameter X₁ is 35, the neighborhood range of the parameter X₁ is a range of 30 (=35−5) through 40 (=35+5), both inclusive.

“Multiplicative” in the item of “type” means that, assuming that a neighborhood lower limit of the set value x of the certain parameter X is L% and a neighborhood upper limit thereof is U%, a range of x×(100+L)/100 through x×(100+U)/100, both inclusive, is assumed to be the neighborhood range. For example, regarding the parameter X₂, illustrated is the fact that the neighborhood lower limit is −10% and the neighborhood upper limit is +10%. Thus, when the set value of the parameter X₂ is 2, the neighborhood range of the parameter X₂ is a range of 1.8 (=2×(100−10)/100) through 2.2 (=2×(100+10)/100), both inclusive.

For example, in a case in which the “type” includes only one of “additive” and “multiplicative”, only the neighborhood lower limit and the neighborhood upper limit for each of the parameters may be indicated by data of the neighborhood range.

The neighborhood range is, for example, input by the user and the like, and stored in the storage unit 101 in advance. For example, the neighborhood range may be assumed to be a permissible range at the time when a value of a specification of a product is deviated from an optimum value due to product variations and the like. Alternatively, the neighborhood range may be set based on the recommended set value and data of a set value selected in advance. For example, a minimum value of a difference between each recommended set value and each set value selected in advance may be set as the neighborhood lower limit of “additive”, and a maximum value thereof may be set as the neighborhood upper limit of “additive”. Alternatively, a value obtained by subtracting 1 from a minimum value of each quotient, which is calculated by division using the set value selected in advance and the recommended set value, may be set as the neighborhood lower limit of “multiplicative”, and a value obtained by subtracting 1 from a maximum value of each quotient may be set as the neighborhood upper limit.

The data set is data in which the set value is associated with the objective function value and the constraint function value related to the result of the experiment using the set value. The objective function value and the constraint function value are values obtained by evaluating the result of the experiment based on the recommended set value as described above. The objective function value and the constraint function value included in the data set are received from the evaluation device 200, for example.

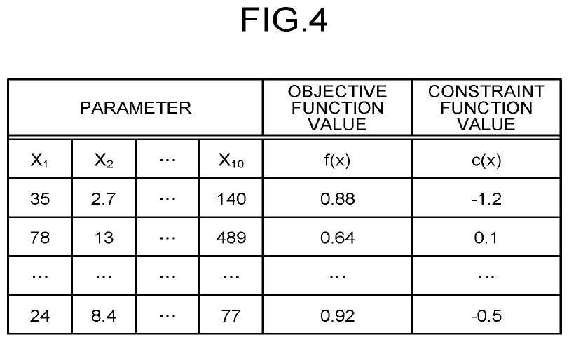

FIG. 4 is a diagram illustrating an example of the data set. In the example of FIG. 4, there are 10 parameters from X₁ to X₁₀, and the set value for each of the parameters, and the objective function value and the constraint function value corresponding thereto are illustrated in each row of the table.

The data set is updated every time the set value is determined by the recommended value determination unit 106, and the determined set value is additionally registered in the data set. The data set is also updated every time the objective function value and the constraint function value corresponding to the recommended set value are acquired from the outside via the reception unit 102, and the objective function value and the constraint function value are associated with the set value to be registered in the data set.

Test data may be registered in the data set in advance. That is, the data set may include a value that is not acquired by actually performing an experiment.

The number of parameters used for the experiment may be one or multiple. In a case in which a plurality of parameters are present, each of the parameters is independent and has an individual value. The set value of each parameter may be any of a continuous value, a discrete value, and a logical value (category variable). That is, a type of the parameter is not particularly limited. For example, the parameter may be a physical parameter such as a temperature and a pressure. Alternatively, the parameter may be a parameter related to the experiment such as a processing time and a processing condition.

One objective function value and one constraint function value may correspond to one set of the parameters X₁ to X₁₀, or a plurality of the objective function values and a plurality of the constraint function values may correspond to one set of the parameters. In a case in which there are a plurality of objective function values corresponding to a plurality of parameters, a comprehensive objective function value and constraint function value may be calculated based on the objective function values.

The data set may include, instead of the objective function value and the constraint function value, output data from which the objective function value and the constraint function value can be calculated. The output data is, for example, data output from the evaluation device 200. The output data may also be constituted of a plurality of items similarly to the parameter, and each of the items may have an individual value. For example, the output data may be detection data of various sensors used for the experiment, or a physical characteristic value and a measurement value of an experiment result or a simulation result.

The storage unit 101 can be configured by any storage medium that is generally used such as a flash memory, a memory card, a random access memory (RAM), a hard disk drive (HDD), and an optical disc.

Returning to FIG. 1, the reception unit 102 receives, from the outside, an input of information required for processing performed by the information processing device 100. For example, the reception unit 102 receives information such as the objective function value and the constraint function value corresponding to the recommended set value (first set value). These pieces of information are registered in the data set as described above. The reception unit 102 may also receive information such as the setting range, the neighborhood range, and an end condition for determining whether to judge the optimum value by the judgement unit 103.

The judgement unit 103 judges whether to continue recommending the set value based on the end condition determined in advance. In a case of stopping recommending the set value, the judgement unit 103 determines the optimum value based on set values that have been recommended. The end condition is that an execution frequency of the experiment or an elapsed time exceeds a threshold, for example. The judgement unit 103 may end recommendation of the set value in a case in which such an end condition is satisfied, and select the optimum value from the set values that have been recommended. A determination method for the optimum value will be described later in detail.

In a case in which the end condition is not satisfied, processing for recommending the set value is performed by the estimation unit 104, the calculation unit 105, and the recommended value determination unit 106. The following describes processing performed by these constituent elements.

The estimation unit 104 calculates an estimation value μ^{f}ₙ(x) (an example of a second estimation value) and an estimation error σ^{f}ₙ(x) (an example of a second estimation error) of the objective function value based on data {xᵢ, yᵢ} (1≤i≤n−1) of a pair of the set value of the parameter and the objective function value. The set value of the parameter of the i-th experiment is xᵢ, which is a D-dimensional vector. The objective function value as a result of the experiment using xᵢ is yᵢ. For example, the estimation unit 104 calculates a square root of sum of squares of an error between the objective function value stored in the data set and the estimation value μ^{f}ₙ(x), and estimates a parameter of μ^{f}ₙ(x) using a regression procedure so that the calculated square root of sum of squares becomes minimum. As the regression procedure, linear regression, Lasso regression, elastic net regression, random forest regression, Gaussian process regression, a neural network, and the like can be used.

For example, when Gaussian process regression is used, the estimation value μ^{f}ₙ(x) of the objective function value is represented by the following expression (4).

μₙ^{f}(x)=μ₀^{f}(x)+k(x)^{T}(K+σ²I)⁻¹(y−m) (4)

For an optional D-dimensional vector x, the estimation value μ^{f}ₙ(x) of the objective function value is calculated by using the expression (4). A mean vector of the objective function value is assumed to be m. The mean vector m is an (n−1)-dimensional vector the i-th element of which is mᵢ=μ₀(xᵢ). y is an (n−1)-dimensional vector the i-th element of which is yᵢ. K is an (n−1)×(n−1) matrix in which a component of the i-th row and the j-th column is K_{i,j}=k(xᵢ, xⱼ). Herein, μ₀(xᵢ) is an optional function, and k(xᵢ, xⱼ) is an optional kernel function. The kernel function may be, for example, an exponential-squared kernel, a Matern kernel, a linear kernel, and the like. k(x) is an (n−1)-dimensional vector the i-th element of which is kᵢ(x)=k(x, xᵢ), and σ² is an optional constant. I represents a unit matrix, and T represents transposition.

The estimation error σ^{f}ₙ(x) of the objective function value is represented by the following expression (5).

σₙ^{f}(x)²=k(x,x)−k(x)^{T}(K+σ²I)⁻¹k(x) (5)

Similarly, the estimation unit 104 calculates an estimation value μ^{c}ₙ(x) (an example of a first estimation value) and an estimation error σ^{c}ₙ(x) (an example of a first estimation error) of the constraint function value based on data (xᵢ, cᵢ) (1≤i≤n−1) of a pair of the set value of the parameter and the constraint function value. For example, the estimation unit 104 calculates the estimation value μ^{c}ₙ(x) of the constraint function value using the expression (4) in which y is replaced with c. The estimation unit 104 also calculates the estimation error σ^{c}ₙ(x) of the constraint function value using the expression (5).

The calculation unit 105 calculates a robust satisfaction probability representing the probability that each parameter satisfies the robust constraint based on the estimation value and the estimation error of the constraint function value.

As described above, the robust constraint means that the constraint function value c(x+δ) always satisfies the condition for the constraint function value even if the set value (second set value) of the parameter varies by δ within the neighborhood range (Δ(x)). In a case in which δ takes a plurality of values, x+5 corresponds to a plurality of set values (third set values) obtained by changing the set value within the neighborhood range. The robust constraint can be interpreted as a constraint that should be satisfied by the constraint function value c(x+δ) when the set value x+δ is input thereto.

For example, first, the calculation unit 105 calculates a relational expression of a constraint satisfaction probability, which is the probability that each parameter and the constraint function value satisfy the condition (for example, equal to or smaller than a threshold, equal to or larger than a threshold, or the like), based on the estimation value and the estimation error of the constraint function value. In a case in which the condition for the constraint function value is equal to or smaller than the threshold 0, a constraint satisfaction probability PFₙ(x) is calculated by the following expression (6), for example. Herein, Φ is a cumulative distribution function of standard normal distribution.

$${PF}_{n} ( x ) = Pr ( c ( x ) \leq 0 ) = Φ ( \frac{- {μ}_{n}^{c} ( x )}{{σ}_{n}^{c} ( x )} ) \qquad ( 6 )$$

The following describes a reason why the constraint satisfaction probability is represented by the expression (6). In a case of Gaussian process regression, it can be estimated that c(x) follows normal distribution with a mean μ(x) and standard deviation σ(x). In this case, assuming that Z=(c(x)−μ(x))/oσx) is satisfied, Z follows standard normal distribution. The probability that c(x) is equal to or smaller than the threshold 0 is equal to the probability that Z is equal to or smaller than −μ(x)/σ(x).

On the other hand, a cumulative distribution function Φ(a) of standard normal distribution represents the probability that a variable Z becomes a value equal to or smaller than a. Thus, the probability that Z is equal to or smaller than −μ(x)/σ(x) is Φ(−μ(x)/σ(x)). In other words, the probability that c(x) is equal to or smaller than the threshold 0 can be calculated by Φ(−μ(x)/σ(x)) as represented by the expression (6).

Next, for the set value x (second set value) of each parameter, the calculation unit 105 calculates a plurality of set values x+δ (third set values) included in the neighborhood range based on the set value x. The calculation unit 105 may randomly sample the set values within the neighborhood range. The calculation unit 105 may calculate the set values x+δ assuming that a set of endpoints of Δ(x) and 0 is δ, or assuming that a value randomly sampled from the set of endpoints of Δ(x) and 0 is δ.

The calculation unit 105 calculates the constraint satisfaction probability for each of the set values using the expression (6). The calculation unit 105 calculates the robust satisfaction probability using a plurality of constraint satisfaction probabilities calculated for the respective set values. For example, the calculation unit 105 calculates, as the robust satisfaction probability RobustPFn(x), a product of the constraint satisfaction probabilities calculated for the respective set values, using the following expression (7).

$${Robust PF}_{n} ( x ) = {\prod }_{δ ∈ \tilde{Δ} ( x )} {PF}_{n} ( x + δ ) \qquad ( 7 )$$

The recommended value determination unit 106 determines a set value to be recommended next, in other words, a set value to be used in the next experiment within the setting range based on the robust satisfaction probability, and the estimation value and the estimation error of the objective function value. Hereinafter, the set value to be recommended may be referred to as a recommended value in some cases.

For example, the recommended value determination unit 106 may detect a set value the robust satisfaction probability of which is equal to or larger than a threshold (a threshold of a probability value) determined in advance, the set value with which the objective function value becomes smaller based on a relational expression of the objective function value with respect to the set value among the set values within the setting range, and may determine the set value to be the set value to be recommended next (recommended value). That is, the recommended value determination unit 106 may search for a set value the objective function value of which is estimated to be smaller than that of the previous set value within the setting range, and employ the set value as the set value (recommended value) to be used for the experiment to be executed next. For example, the recommended value determination unit 106 can find a value the objective function value of which becomes smaller using various optimization method such as full search, random search, grid search, a gradient method, L-BFGS, DIRECT, CMA-ES, and a multi-start local search method.

Alternatively, the recommended value determination unit 106 may determine the recommended value based on a product of an acquisition function (first acquisition function) and the robust satisfaction probability. The acquisition function is a function that is obtained based on the estimation value and the estimation error of the objective function value. For example, the recommended value determination unit 106 determines the recommended value using a robust acquisition function (second acquisition function, details thereof will be described later) as a function based on a product of the acquisition function and the robust satisfaction probability.

For example, the recommended value determination unit 106 may recommend a set value with which an output of the robust acquisition function becomes optimum. In a case in which a larger output value of the acquisition function (acquisition function value) indicates better evaluation, the recommended value determination unit 106 recommends a set value with which the robust acquisition function becomes maximum. In a case in which a smaller acquisition function value indicates better evaluation, the recommended value determination unit 106 recommends a set value with which the robust acquisition function becomes minimum. The following exemplifies a case in which a larger acquisition function indicates better evaluation.

As the acquisition function, for example, Probability of Improvement (PI) may be used, or Expected Improvement (EI) may be used. As the acquisition function, Upper Confidence Bound (UCB), Thompson Sampling (TS), Entropy Search(ES), and Mutual Information (MI) may be used.

For example, in a case of using Expected Improvement as the acquisition function, first, the recommended value determination unit 106 calculates, using μ^{f}ₙ(x) and PFₙ(x), a set value x⁺ₙ with which an objective function value μ^{f}ₙ(x) becomes minimum at the present time by the following expression (8).

$${x}_{n}^{+} = {arg min}_{x ∈ {\{ {\tilde{x}}_{i} \}}_{i = 1}^{n - 1} , {RobustPF}_{n} ( x ) \geq {p}_{th}} {μ}_{n}^{f} ( x ) \qquad ( 8 )$$

The recommended value determination unit 106 also calculates Expected Improvement EIₙ(x) by the following expression (9) based on x⁺ₙ, μ^{f}ₙ(x), and of σ^{f}ₙ(x).

EIₙ(x)=σₙ^{f}(x)(ZₙΦ(Zₙ)+ϕ(Zₙ)) (9)

φ is a probability density function of standard normal distribution. Zn is represented by the following expression (10).

$${Z}_{n} = \frac{{μ}_{n}^{f} ( x ) - {μ}_{n}^{f} ( {x}_{n}^{+} )}{{σ}_{n}^{f} ( x )} \qquad ( 10 )$$

The recommended value determination unit 106 calculates a robust acquisition function RobustEICn(x) as a product of EIn(x) and RobustPFn(x) by the following expression (11).

RobustEICₙ(x)=EIₙ(x)RobustPFₙ(x) (11)

The recommended value determination unit 106 then calculates a set value x^{˜}ₙ with which the robust acquisition function becomes maximum by the following expression (12).

$${\tilde{x}}_{n} = {arg max}_{x ∈ χ} {RobustEIC}_{n} ( x ) \qquad ( 12 )$$

For example, the recommended value determination unit 106 determines the calculated set value x^{˜}ₙ to be the recommended value. The recommended value determination unit 106 does not recommend the determined recommended value as it is, but may select or search for a plurality of set values in the neighborhood range of the determined recommended value (hereinafter, referred to as neighborhood set values), and recommend the set values as new recommended values in order.

For example, the recommended value determination unit 106 may randomly select a plurality of set values from the neighborhood range of the determined set value (hereinafter, referred to as neighborhood set values), and output the selected set values as recommended values in order.

The recommended value determination unit 106 may newly search for a neighborhood set value with which the acquisition function based on the estimation value and the estimation error of the objective function value becomes maximum within the neighborhood range of the determined set value, and determine the neighborhood set value to be the recommended value.

The recommended value determination unit 106 may calculate, by the following expression (13), a point δₙ that minimize a constraint satisfaction probability PFₙ(x^{˜}ₙ+δ) with respect to a variation δ in Δ(x^{˜}ₙ) while fixing the set value x^{˜}ₙ, and cause the recommended value to be xₙ=x^{˜}ₙ+δₙ.

$${δ}_{n} = {arg min}_{δ ∈ Δ ( {\tilde{x}}_{n} )} {PF}_{n} ( {\tilde{x}}_{n} + δ ) \qquad ( 13 )$$

The recommended value determination unit 106 may newly search for a neighborhood set value with which the estimation error of the objective function value or the estimation error of the constraint function value becomes maximum within the neighborhood range of the determined set value, and determine the neighborhood set value to be the recommended value.

Heretofore, it has been assumed that the data set is present. However, for example, in a case in which the user performs an experiment for the first time, there may be a situation in which test data is not registered in the data set. Even in such a situation, the user may desire to use the set value recommended by the information processing device 100 in some cases. In such a case, the information processing device 100 cannot determine the recommended value by the method described above, so that the information processing device 100 may cause a value determined in advance (initial value of the set value) to be the recommended value, or may determine the recommended value in accordance with a rule determined in advance. The rule is, for example, a rule for determining the set value using any of a random number, a Latin square, and a Sobol sequence. That is, the set value recommended first (initial value) may be a value determined in advance, or a value that is determined in accordance with a rule determined in advance (a rule of using a random number, a Latin square, or a Sobol sequence).

As described above, in a case in which the end condition is satisfied, the judgement unit 103 determines the optimum value from the set values that have been recommended. The following describes a method of determining the optimum value by the judgement unit 103.

The judgement unit 103 determines, to be the optimum value, the recommended value the robust satisfaction probability of which is equal to or larger than a threshold and the objective function value of which is smaller or larger than that of the other recommended values among the recommended values that have been output.

For example, the judgement unit 103 determines, to be the optimum value, the set value with which the objective function value stored in the storage unit 101 becomes optimum (minimum or maximum). The judgement unit 103 may determine, to be the optimum value, the set value with which the estimation value of the constraint function value is equal to or smaller than a threshold, and the objective function value or the estimation value of the objective function value is minimum, among the set values that have been recommended. Among the set values the robust acquisition function of which is maximum stored in the storage unit 101, the judgement unit 103 may determine, to be the optimum value, the set value with which the estimation value of the constraint function value is equal to or smaller than a threshold, and the objective function value or the estimation value of the objective function value is minimum.

Additionally, among the set values the robust acquisition function of which is maximum stored in the storage unit 101, the judgement unit 103 may determine, to be the optimum value, a parameter with which the robust satisfaction probability is equal to or larger than a threshold determined in advance (a threshold of a probability value) and the estimation value of the objective function value is minimum. That is, the judgement unit 103 may determine, to be the optimum value, a parameter x⁺ₙ₊₁ that minimizes the estimation value of the objective function value in accordance with the following expression (14).

$${x}_{n + 1}^{+} = {arg min}_{x ∈ {\{ {\tilde{x}}_{i} \}}_{i = 1}^{n} , {RobustPF}_{n + 1} ( x ) \geq {p}_{th}} {μ}_{n + 1}^{f} ( x ) \qquad ( 14 )$$

The output control unit 107 outputs a processing result of each constituent element. For example, the output control unit 107 outputs the recommended set value and the optimum value. The output control unit 107 may receive an instruction via the reception unit 102, and output data stored in the storage unit 101 such as the data set.

An output format of the output control unit 107 is not particularly limited, and may be a table or an image, for example. For example, the output control unit 107 may generate and output a graph based on data such as the data set.

In a case in which the information processing device 100 includes a simulator, the simulator sets the recommended set value to a parameter of a model to execute a simulation, and calculates the objective function value based on a simulation result. A calculation expression for the objective function value is determined in advance.

The information processing device 100 may include a processing unit obtained by integrating at least part of functions of the reception unit 102, the judgement unit 103, the estimation unit 104, the calculation unit 105, the recommended value determination unit 106, and the output control unit 107.

The respective units described above (the reception unit 102, the judgement unit 103, the estimation unit 104, the calculation unit 105, the recommended value determination unit 106, and the output control unit 107) are implemented by one or more hardware processors, for example. For example, each of the units described above may be implemented by causing a processor such as a central processing unit (CPU) to execute a computer program, that is, by software. Each of the units described above may also be implemented by a processor such as a dedicated integrated circuit (IC), that is, by hardware. Each of the units described above may also be implemented by using both of software and hardware. In a case of using a plurality of processors, each of the processors may implement one of the units, or may implement two or more of the units.

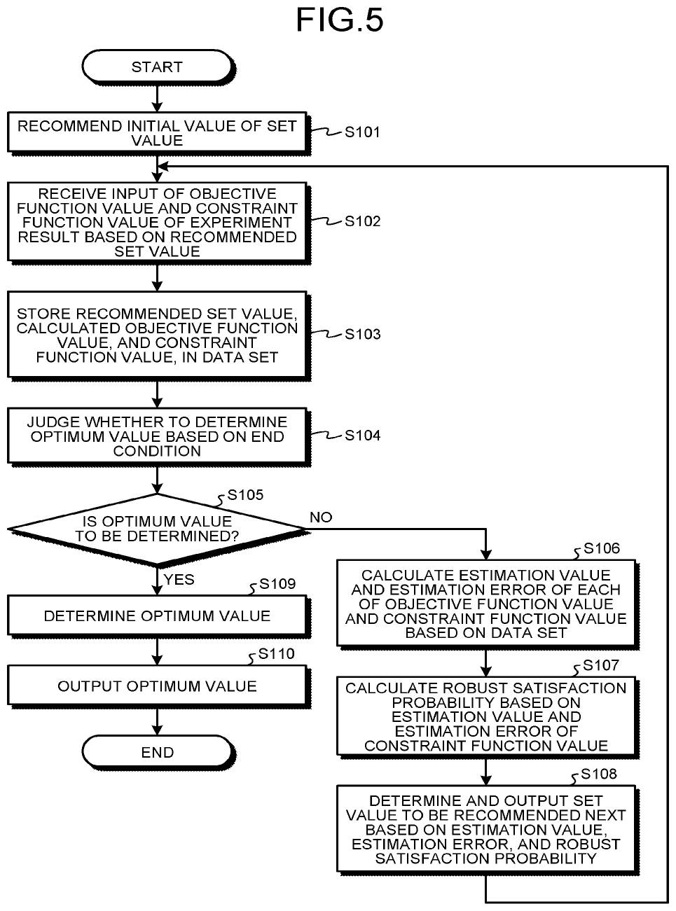

Next, the following describes determination processing for the optimum value performed by the information processing device 100 according to the present embodiment. FIG. 5 is a flowchart illustrating an example of the determination processing according to the present embodiment.

The recommended value determination unit 106 recommends an initial value of the set value (Step S101). As described above, the initial value may be a value determined in advance, or a value that is selected from values in the setting range based on a rule determined in advance. The initial value is output from the information processing device 100 to the user who performs the experiment, or the simulator (the evaluation device 200 and the like), for example.

The experiment is performed by using the recommended initial value of the set value. The evaluation device 200 or the simulator calculates the objective function value and the constraint function value based on a result of the experiment based on the recommended set value.

The reception unit 102 receives the calculated objective function value and constraint function value from the evaluation device 200 or the simulator (Step S102). The reception unit 102 associates the recommended set value with the calculated objective function value and constraint function value to be stored in the data set of the storage unit 101 (Step S103).

The judgement unit 103 judges whether to determine the optimum value based on the end condition (Step S104). The end condition is determined in advance as described above.

If it is judged that the optimum value is not determined (No at Step S105), the estimation unit 104 estimates the estimation value and the estimation error of each of the objective function value and the constraint function value of each parameter based on the stored data set (the recommended set value, the corresponding objective function value and constraint function value) (Step S106).

The calculation unit 105 calculates the robust satisfaction probability as the probability that each parameter satisfies the robust constraint based on the estimation value and the estimation error of the constraint function value (Step S107).

The recommended value determination unit 106 determines and outputs the set value to be recommended next (recommended value) based on the estimation value and the estimation error of the constraint function value, and the robust satisfaction probability (Step S108). For example, the recommended value determination unit 106 determines, to be the next recommended value, the set value with which the robust acquisition function as a product of the robust satisfaction probability and Expected Improvement becomes maximum. The recommended value determination unit 106 may determine, to be the next recommended value, a neighborhood set value of the determined set value.

The next experiment is further performed by using the set value output at Step S108. Thereafter, the process returns to Step S102, and the processing is repeated. That is, determination and judgement of the set value are repeated.

If it is judged that the optimum value is determined at Step S105 (Yes at Step S105), the judgement unit 103 determines the optimum value based on the set values that have been recommended (Step S109). The output control unit 107 outputs the determined optimum value (Step S110), and ends the determination processing for the optimum value.

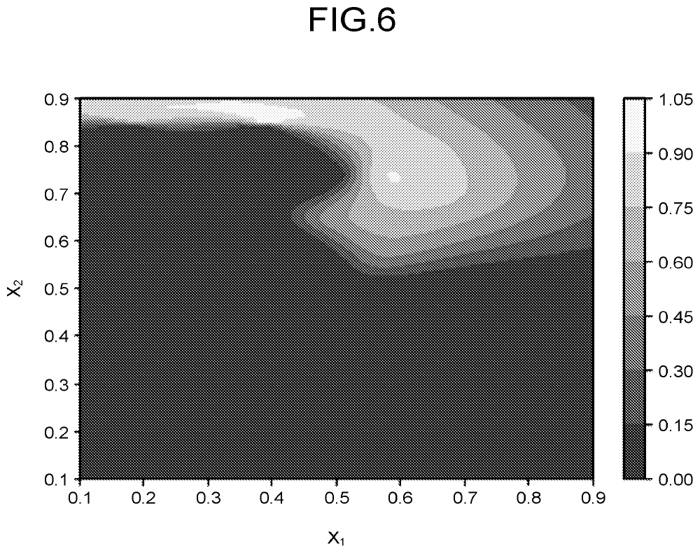

Next, the following describes an example of an output by the output control unit 107. The output control unit 107 may be configured to output the robust satisfaction probability. FIG. 6 is a diagram illustrating an example of a display screen displaying the estimated robust satisfaction probability. A vertical axis and a horizontal axis in FIG. 6 respectively indicate set values of different parameters. Contour lines represent robust satisfaction probabilities. The display screen in FIG. 6 is an example of information indicating a relation between the set value of the parameter and the robust satisfaction probability. By displaying the display screen as in FIG. 6, for example, the user can quickly check whether the parameter satisfies the robust constraint.

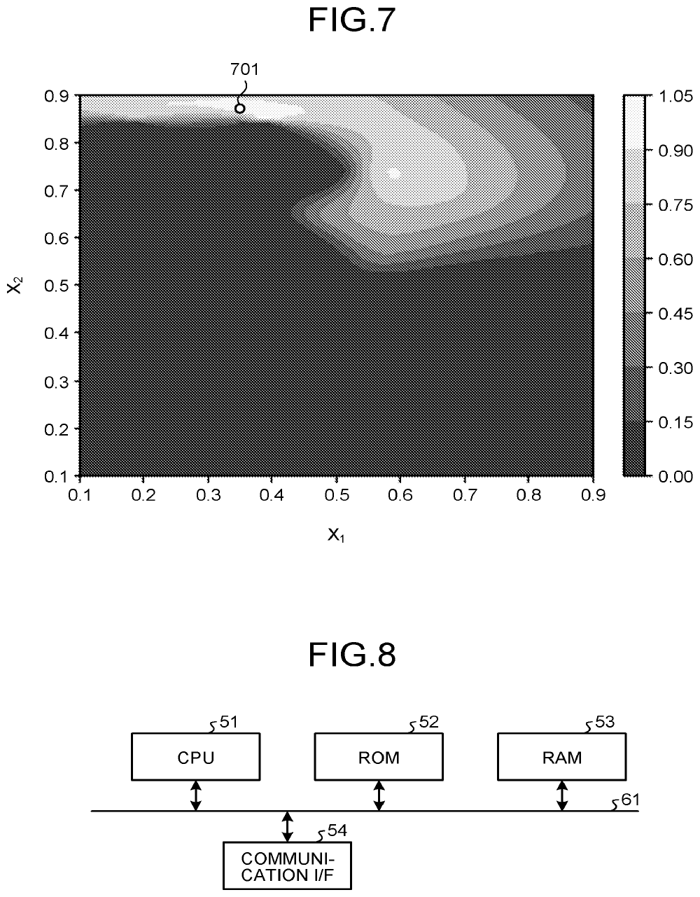

FIG. 7 is a diagram illustrating an example of a display screen displaying the estimated optimum value and the robust satisfaction probability. A point 701 represents the estimated optimum value. Similarly to FIG. 6, a vertical axis and a horizontal axis respectively indicate set values of different parameters, and contour lines represent the robust satisfaction probabilities. As illustrated in FIG. 7, the optimum value (point 701) is present at a position where the robust satisfaction probability is high. At Step S110 in FIG. 5, the optimum value may be output via the display screen illustrated in FIG. 7, for example.

As described above, the information processing device 100 according to the present embodiment estimates the relational expression between the set value and the robust satisfaction probability related to the set value, and recommends the set value to be used for the next experiment based on the relational expression. When the set value is continuously recommended and the experiment is repeated, it is possible to obtain, as the optimum value, the set value within the neighborhood range the constraint function value of which always satisfies a condition, that is, satisfies the robust constraint, and the objective function value of which is small. By using Bayesian optimization, the set value that satisfies the robust constraint and causes the objective function value to be small can be obtained with a smaller number of times of experiments.

In the present embodiment, a plurality of times of experiments (simulations) are not required to be performed per one parameter, so that a time for obtaining the optimum set value of the parameter can be shortened. That is, processing of obtaining the set value of the parameter can be performed more efficiently. Additionally, by visualizing the robust satisfaction probability for each parameter, it is possible to easily check whether the obtained set value is optimum.

Next, the following describes a hardware configuration of the information processing device according to the embodiment with reference to FIG. 8. FIG. 8 is an explanatory diagram illustrating a hardware configuration example of the information processing device according to the embodiment.

The information processing device according to the embodiment includes a control device such as a CPU 51, a storage device such as a read only memory (ROM) 52 and a RAM 53, a communication I/F 54 that is connected to a network to perform communication, and a bus 61 that connects the respective components.

A computer program executed by the information processing device according to the embodiment is embedded and provided in the ROM 52 and the like.

The computer program executed by the information processing device according to the embodiment may be recorded in a computer-readable recording medium such as a compact disc read only memory (CD-ROM), a flexible disk (FD), a compact disc recordable (CD-R), and a digital versatile disc (DVD), as an installable or executable file to be provided as a computer program product.

Furthermore, the computer program executed by the information processing device according to the embodiment may be stored in a computer connected to a network such as the Internet and provided by being downloaded via the network. Furthermore, the computer program executed by the information processing device according to the embodiment may be provided or distributed via a network such as the Internet.

The computer program executed by the information processing device according to the embodiment may cause the computer to function as each of the components of the information processing device described above. This computer can be executed when the CPU 51 reads out the computer program onto a main storage device from a computer-readable storage medium.

Configuration Examples of the embodiment are described below.

### Configuration Example 1

An information processing device comprising
one or more hardware processors configured to:
   based on a constraint function value that is an output of a constraint function when one or more first set values are input for one or more parameters, estimate a first estimation value and a first estimation error of the constraint function value; and
   based on the first estimation value and the first estimation error, calculate a robust satisfaction probability representing a probability that one or more second set values for the one or more parameters satisfy a robust constraint that the constraint function value when inputting a plurality of third set values should satisfy, the plurality of third set values being obtained by changing the one or more second set values in a neighborhood range determined in advance based on the one or more second set values.

### Configuration Example 2

The information processing device according to Configuration Example 1, wherein
the one or more hardware processors are configured to:
   obtain a relational expression for calculating a satisfaction probability representing a probability of satisfying a condition for the constraint function value;
   calculate satisfaction probabilities using the relational expression, for the plurality of third set values; and
   calculate the robust satisfaction probability using the satisfaction probabilities calculated for the plurality of third set values.

### Configuration Example 3

The information processing device according to Configuration Example 2, wherein the one or more hardware processors are configured to calculate, as the robust satisfaction probability, a product of the satisfaction probabilities calculated for the plurality of third set values.

### Configuration Example 4

The information processing device according to any one of Configuration Examples 1 to 3, wherein
the one or more hardware processors are configured to:
   based on an objective function value that is an output of an objective function when the first set value is input, estimate a second estimation value and a second estimation error of the objective function value; and
   determine a recommended value that is a set value to be recommended based on the robust satisfaction probability, the second estimation value, and the second estimation error.

### Configuration Example 5

The information processing device according to Configuration Example 4, wherein the one or more hardware processors are configured to determine, to be the recommended value, a set value the robust satisfaction probability of which is equal to or larger than a threshold and the second estimation value of which is smaller than second estimation values of other set values among set values within a setting range representing a range that the set value is able to take.

### Configuration Example 6

The information processing device according to Configuration Example 4, wherein
the one or more hardware processors are configured to:
   calculate a first acquisition function based on the second estimation value and the second estimation error;
   calculate a second acquisition function that is a product of the robust satisfaction probability and the first acquisition function; and
   determine, to be the recommended value, a set value with which an output of the second acquisition function becomes optimum within a setting range representing a range that the set value is able to take.

### Configuration Example 7

The information processing device according to Configuration Example 4, wherein the one or more hardware processors are configured to determine, to be new recommended values, a plurality of set values that are selected or retrieved within the neighborhood range based on the determined recommended value.

### Configuration Example 8

The information processing device according to Configuration Example 4, wherein the one or more hardware processors are configured to determine, to be a new recommended value, a set value with which a satisfaction probability representing a probability of satisfying a condition for the constraint function value becomes minimum within the neighborhood range based on the determined recommended value.

### Configuration Example 9

The information processing device according to Configuration Example 4, wherein the one or more hardware processors are configured to determine, to be an optimum value representing an optimum set value, a candidate set value the robust satisfaction probability of which is equal to or larger than a threshold and the objective function value of which is smaller or larger than the objective function value of another candidate set value among a plurality of recommended values determined for a plurality of constraint function values and a plurality of objective function values that are outputs of an objective function when a first set value is input.

### Configuration Example 10

The information processing device according to Configuration Example 9, wherein the one or more hardware processors are configured to determine, to be the optimum value, a candidate set value the robust satisfaction probability of which is equal to or larger than a threshold and the objective function value of which becomes minimum or maximum among the plurality of recommended values determined for the plurality of constraint function values and the plurality of objective function values.

### Configuration Example 11

The information processing device according to any one of Configuration Examples 1 to 10, wherein the one or more hardware processors are further configured to output the robust satisfaction probability.

### Configuration Example 12

The information processing device according to Configuration Example 11, wherein the one or more hardware processors are configured to output information indicating a relation between set values of the one or more parameters and the robust satisfaction probability.

### Configuration Example 13

The information processing device according to any one of Configuration Examples 1 to 12, wherein
the one or more hardware processors are configured to implement:
   an estimation unit configured to estimate the first estimation value and the first estimation error; and
   a calculation unit configured to calculate the robust satisfaction probability.

### Configuration Example 14

An information processing method executed by an information processing device, the information processing method comprising:
based on a constraint function value that is an output of a constraint function when one or more first set values are input for one or more parameters, estimating a first estimation value and a first estimation error of the constraint function value; and
based on the first estimation value and the first estimation error, calculating a robust satisfaction probability representing a probability that the one or more second set values for the one or more parameters satisfy a robust constraint that the constraint function value when inputting a plurality of third set values should satisfy, the plurality of third set values being obtained by changing second set values in a neighborhood range determined in advance based on the one or more second set values.

### Configuration Example 15

A computer program product comprising a computer-readable medium including programmed instructions, the instructions causing a computer to execute:
based on a constraint function value that is an output of a constraint function when one or more first set values are input for one or more parameters, estimating a first estimation value and a first estimation error of the constraint function value; and
based on the first estimation value and the first estimation error, calculating a robust satisfaction probability representing a probability that the one or more second set values for the one or more parameters satisfy a robust constraint that the constraint function value when inputting a plurality of third set values should satisfy, the plurality of third set values being obtained by changing second set values in a neighborhood range determined in advance based on the one or more second set values.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising
one or more hardware processors configured to:
based on a constraint function value that is an output of a constraint function when one or more first set values are input for one or more parameters, estimate a first estimation value and a first estimation error of the constraint function value; and
based on the first estimation value and the first estimation error, calculate a robust satisfaction probability representing a probability that one or more second set values for the one or more parameters satisfy a robust constraint that the constraint function value when inputting a plurality of third set values should satisfy, the plurality of third set values being obtained by changing the one or more second set values in a neighborhood range determined in advance based on the one or more second set values.

2. The device according to claim 1, wherein
the one or more hardware processors are configured to:
obtain a relational expression for calculating a satisfaction probability representing a probability of satisfying a condition for the constraint function value;
calculate satisfaction probabilities using the relational expression, for the plurality of third set values; and
calculate the robust satisfaction probability using the satisfaction probabilities calculated for the plurality of third set values.

3. The device according to claim 2, wherein the one or more hardware processors are configured to calculate, as the robust satisfaction probability, a product of the satisfaction probabilities calculated for the plurality of third set values.

4. The device according to claim 1, wherein
the one or more hardware processors are configured to:
based on an objective function value that is an output of an objective function when the first set value is input, estimate a second estimation value and a second estimation error of the objective function value; and
determine a recommended value that is a set value to be recommended based on the robust satisfaction probability, the second estimation value, and the second estimation error.

5. The device according to claim 4, wherein the one or more hardware processors are configured to determine, to be the recommended value, a set value the robust satisfaction probability of which is equal to or larger than a threshold and the second estimation value of which is smaller than second estimation values of other set values among set values within a setting range representing a range that the set value is able to take.

6. The device according to claim 4, wherein
the one or more hardware processors are configured to:
calculate a first acquisition function based on the second estimation value and the second estimation error;
calculate a second acquisition function that is a product of the robust satisfaction probability and the first acquisition function; and
determine, to be the recommended value, a set value with which an output of the second acquisition function becomes optimum within a setting range representing a range that the set value is able to take.

7. The device according to claim 4, wherein the one or more hardware processors are configured to determine, to be new recommended values, a plurality of set values that are selected or retrieved within the neighborhood range based on the determined recommended value.

8. The device according to claim 4, wherein the one or more hardware processors are configured to determine, to be a new recommended value, a set value with which a satisfaction probability representing a probability of satisfying a condition for the constraint function value becomes minimum within the neighborhood range based on the determined recommended value.

9. The device according to claim 4, wherein the one or more hardware processors are configured to determine, to be an optimum value representing an optimum set value, a candidate set value the robust satisfaction probability of which is equal to or larger than a threshold and the objective function value of which is smaller or larger than the objective function value of another candidate set value among a plurality of recommended values determined for a plurality of constraint function values and a plurality of objective function values that are outputs of an objective function when a first set value is input.

10. The device according to claim 9, wherein the one or more hardware processors are configured to determine, to be the optimum value, a candidate set value the robust satisfaction probability of which is equal to or larger than a threshold and the objective function value of which becomes minimum or maximum among the plurality of recommended values determined for the plurality of constraint function values and the plurality of objective function values.

11. The device according to claim 1, wherein the one or more hardware processors are further configured to output the robust satisfaction probability.

12. The device according to claim 11, wherein the one or more hardware processors are configured to output information indicating a relation between set values of the one or more parameters and the robust satisfaction probability.

13. The device according to claim 1, wherein
the one or more hardware processors are configured to implement:
an estimation unit configured to estimate the first estimation value and the first estimation error; and
a calculation unit configured to calculate the robust satisfaction probability.

14. An information processing method executed by an information processing device, the information processing method comprising:
based on a constraint function value that is an output of a constraint function when one or more first set values are input for one or more parameters, estimating a first estimation value and a first estimation error of the constraint function value; and
based on the first estimation value and the first estimation error, calculating a robust satisfaction probability representing a probability that the one or more second set values for the one or more parameters satisfy a robust constraint that the constraint function value when inputting a plurality of third set values should satisfy, the plurality of third set values being obtained by changing second set values in a neighborhood range determined in advance based on the one or more second set values.

15. A computer program product comprising a computer-readable medium including programmed instructions, the instructions causing a computer to execute:
based on a constraint function value that is an output of a constraint function when one or more first set values are input for one or more parameters, estimating a first estimation value and a first estimation error of the constraint function value; and
based on the first estimation value and the first estimation error, calculating a robust satisfaction probability representing a probability that the one or more second set values for the one or more parameters satisfy a robust constraint that the constraint function value when inputting a plurality of third set values should satisfy, the plurality of third set values being obtained by changing second set values in a neighborhood range determined in advance based on the one or more second set values.
